(19) United States
(12) Patent Application Publication
(10) Pub. No.: US 2007/0250447 A1
(43) Pub. Date: Oct. 25, 2007

(54) Method And Apparatus For Boostrapping Mobile A/V Jukeboxes

(75) Inventors: Jozef Pieter Van Gassel, Sevenum (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,613

(22) PCT Filed: Oct. 5, 2005
(86) PCT No.: PCT/IB05/53279

§ 371 Date: Apr. 20, 2007

Related U.S. Application Data
(60) Provisional application No. 60/621,868, filed on Oct. 25, 2004.

(51) Int. Cl. H04L 9/32

(52) U.S. Cl. 705/57

(57) ABSTRACT

Kiosk/Download Stations (2) are located in public places, such as retail establishments, malls, and so forth, for providing customers who own or newly purchase portable audio and/or audio/visual playback/recording devices (8) to be provided a service for rapidly downloading from the Kiosk (2) into a given device (8) newly purchased program material and/or previously purchased program material of the associated customer, the Kiosk (2) encoding the program material in a manner to only permit the customer to produce a backup copy by uploading the program material into the customer's PC (12), and only download the program material from the PC (12) into the customer's single device (8), while preventing any other copying of the program material from either the customer's device (8) or PC (12).

The field of the present invention relates generally to systems and apparatus associated with mobile hard disk-based consumer electronic products, and more specifically relates to audio and/or audio/video jukeboxes.

With the introduction into the marketplace of mobile jukeboxes, and the continued rapid expansion of such devices, such as the Apple iPod®, Philips HDD100 Recording Audio Jukeboxes®, and the Archos AV300® for playback and recording of audio/video material, it has become increasingly easier for users to illegally copy program material. The owners of the copyright to such materials are concerned with violation of their copyright rights, and retail suppliers of such devices and program material are concerned with reduced sales. Insufficient safeguards exist to prevent users of such devices from copying audio/video material from CD's and DVD's they have purchased in the past, or borrowed from others. Also, downloads from various Internet sites provide an opportunity for users of such devices to illegally obtain audio/visual program material for playback on their mobile devices. To help prevent such illegal access to program material, copy-controlled CD's have been introduced into the marketplace.

Another problem in the art relative to users of such mobile audio/video jukeboxes, regardless of whether they intend to legally or illegally copy program material, is that they typically must expend from five to ten minutes per CD to copy audio material into their mobile device, and a longer time for audio/video program material into a device capable of recording and playing back both the audio and video content. For a user to record a large collection of audio programming from a typical average size collection of CD's, they may have to spend hours recording such material into their mobile devices, or even days for a very large collection of such material. An even longer time would be required for recording a large collection of audio/video material. Also, such users require a personal computer (PC) if they intend to record material into their devices from the Internet. All of these problems for users of such mobile devices presents an opportunity for retailers of both content and devices, and for copyright holders, to develop methods and apparatus for providing the users of such mobile devices an economic and legal resource for obtaining desired program material, such as audio or audio/video, or software (upgraded), maps for navigation and other digital objects, for example.

The present invention overcomes the problems in the prior art by providing a method and apparatus for economically permitting users of mobile audio and/or audio/video jukeboxes to easily obtain desired program material in a timely and efficient manner. In one embodiment of the invention, retailers are able to provide purchasers of new mobile jukeboxes the ability to have the retailer transfer audio or audio/video material, depending upon the device purchased, onto the hard drive of the device from a database maintained by the retailer of program material that was previously purchased or presently purchased by the customer or purchaser. Such audio or audio/video material, prior to transfer for recording on the hard disk of the device, is encoded with a public key via a download station controlled by the retailer, whereby the encrypted program material is then transferred for recordation in the mobile device. The encryption may be made in a manner to permit the purchaser or user of a mobile device to download a copy of the recorded material from their mobile device into the hard drive of their personal PC, for maintaining a backup copy of the program material. The encrypted material is protected in a manner to only permit the user to transfer the program material from their home computer back to the mobile device, but not to any other devices or PC's. In this manner, the copyright rights of the originators or present owners of the program material are protected, and the retailer is provided an opportunity to in addition to selling such mobile devices, also provide a service for permitting the rapid and economic transfer of a customer's previously owned program material onto the newly purchased mobile device.

In another embodiment of the device, a user of a mobile device can purchase additional program material from a retailer at any desired time. The retailer would maintain a large database of program material such as audio material, audio/video material, and so forth, to permit the purchaser of new content for their mobile device access to a myriad number of different program material. Upon purchase of such material from the retailer, the program material would be encoded, encrypted and downloaded onto the hard drive of the mobile device, in the manner previously indicated for purchasers of new devices who have program material that they previously own and maintain coded references therefore in the shop or retailer's database for download to their new device. Note that the shop links device users to presently stored content through use of references. A large database is retained by the shop, in this example, for storing all of the program material, and a list of user/devices individually referring to program material previously purchased.

In another embodiment of the invention, to provide retailers the ability to offer the download services of the previously mentioned embodiments, the retailer would maintain a Kiosk/Download Station, a large database of various program material, and a database of customer owned program material, along with necessary information associated with the various mobile devices that may be available in the marketplace at any given time. As previously indicated, the Kiosk/Download Station only stores coded references to the content owned by the user in a database not including the actual content itself, the latter being stored in a separate large database. These databases would be continually updated as new program material becomes available, and as new mobile devices become available. Also, as the customer purchases new program material, the customer's previously owned program database containing references would be similarly updated. In order to conserve memory space, the retailers general content database, or large program material database can be tied to the customer owned material database, via coded references related to CD's and/or DVD's or other program material previously purchased by the customer. The retailer can obtain access to such program material from the general content database through use of the codes for such material stored in the customer database.

Various embodiments of the present invention are described in detail below with reference to the drawings, in which like items are identified by the same reference designation, wherein:

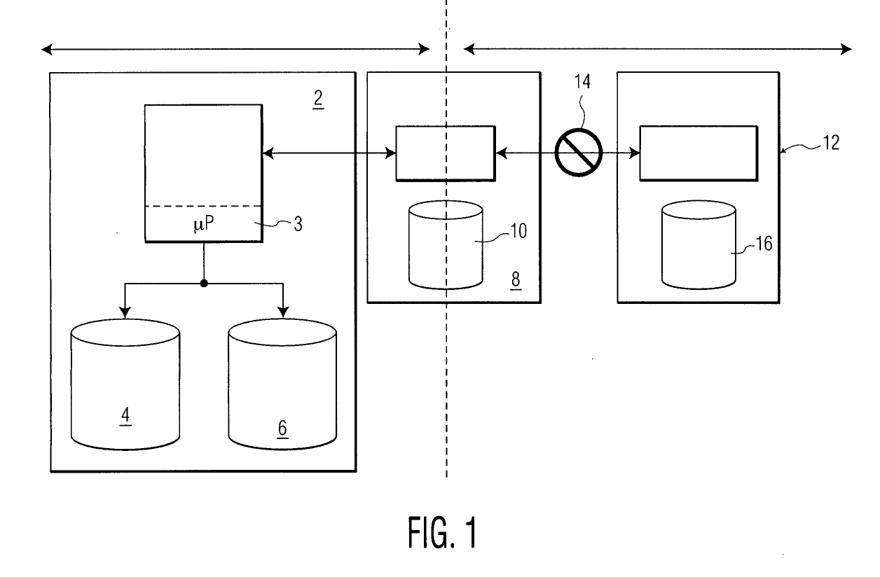

FIG. 1 is a block schematic diagram of apparatus for providing various of the services involved with different embodiments of the invention;

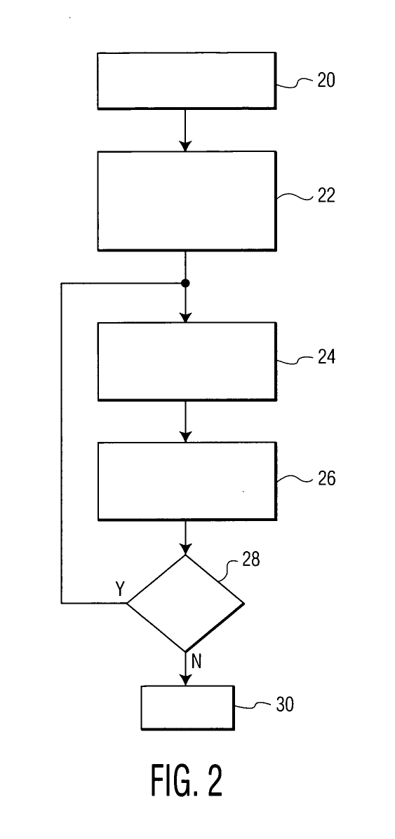

FIG. 2 is a flowchart showing the steps involved for downloading program material “owned” by a customer from a shop or retailer's database onto the hard drive of a newly purchased mobile device, for one embodiment of the invention; and

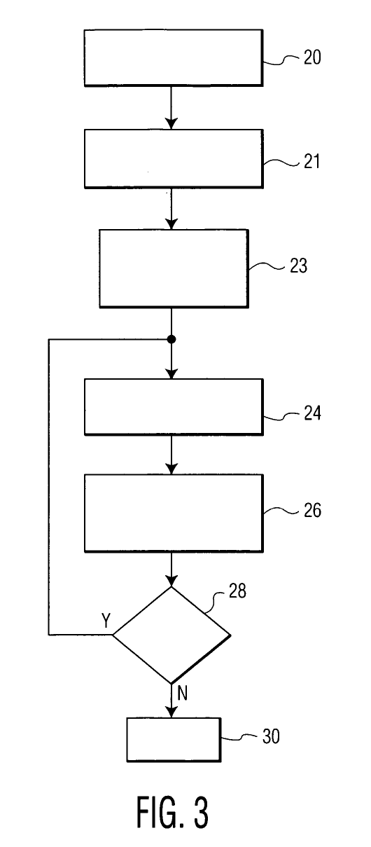

FIG. 3 is a flowchart showing the steps involved for a retailer or shop owner to sell new program content to a mobile device jukebox user, whereby the new program material is downloaded from the retailer's database onto the hard drive of the associated mobile jukebox device, for another embodiment of the invention.

With reference to FIG. 1, a system for providing the various aspects of the present invention is shown. Kiosk/Download Stations 2 that can be located in the shops of retailers, or in appropriate public places, include a content database 4 for storing digitized program material (audio, audio/video, software, navigation, and other material, for example), and a customer/device database 6 for maintaining information associated with customers and mobile devices that the customers may presently own or purchase in the future. As previously described, a mobile or portable audio jukebox or audio/video recorder/player 8, shown as “portable” device 8 in FIG. 1, can be connected to the Kiosk/Download Station 2 for downloading audio programming material, such as songs, musical works, and/or if applicable, audio/video program material for recording in a memory 10 of portable device 8 in this example. The portable device 8 also can be connected to a home personal computer (PC) 12 of the user or customer. Note that the symbol identified by reference numeral 14 is for indicating that exchange of data between device 8 and PC 12 is not always allowed. The PC 12 retains the backup copy of the program material in a memory 16 thereof. As previously explained, the encryption is configured in order to ensure that only the portable device 8 can gain access to backup copy on the memory 16 of PC 12, in order to prevent unauthorized use of the program material by other than the owner of the portable device 8. In this regard, in the Kiosk/Download Station 2, the customer and device database 6 contains identification (ID) and keys associated with customers and their respective devices. The content database 4 is relatively large, and as indicated can contain, for example, the digitized audio and/or video program material (typically as MP3 files) of a majority of customers. The program material is encoded with reference codes for easy access. If a customer happens to purchase from or bring to a retailer or shopkeeper associated with a Kiosk/Download Station 2 program material not contained in content database 4, such material can easily be transferred with appropriate reference coding into content database 4. Obviously, the portable device 8 can be moved by a user between a shop or public place where Kiosk/Download Station 2 is located, and the user's home where their PC 12 is located.

Digital Restrictions Management (DRM) systems typically incorporate public/private key encryption of data or program material, whereby the data or program material is transferable to portable devices in a manner ensuring that the data or program material can only be decrypted by a designated portable or mobile device. In one embodiment of the invention, such encryption is utilized in the shop system or Kiosk/Download Station 2 through use of the public keys of the portable or mobile devices 8, respectively, for purposes of downloading program material to such devices 8. As previously mentioned, through use of such keys, the program material can be backed up to a home PC 12, for example, but can only be played back to a single designated portable or mobile device 8, due to the public/private key encryption used.

In another embodiment of the invention, the portable or mobile device 8 can be configured to allow it to decrypt the program material downloaded from the shop or Kiosk/Download Station 2 content database 4, through use of the mobile devices 8 securely stored secret key. Alternatively, it is preferred that the decryption and re-encryption can be done on the fly while sending the program material to the device 8. Subsequently, the mobile device 8 is further configured to re-encrypt the program material through use of the public key of the user's PC 12 or home server (not shown), and transfer the program material to the PC 12. In this manner, the audio/video content stored in the memory 16 of the PC 12, or associated home server, can only be played back by the PC 12 or the home server through use of the associated secret key. In this manner, further distribution of the program material is prevented.

In yet another embodiment of the invention, the mobile device 8 can be configured to prevent any downloading of program material in the memory 10 to a PC 12, or other memory device, in order to better secure the associated program material.

The Kiosk/Download Stations 2 may include personal computers or microprocessors or servers (not shown) that are configured to place the desired program material into a desired format in bit-rate (associated with given levels of quality), and can be further configured for keying into a given portable or mobile device 8 an appropriate key for maintaining digital rights. Also, the connections made between the Kiosk/Download Stations 2, and the mobile devices 8, and the PC/home servers 12 can be typically provided by either a wire or wireless connection, as is known in the art. For example, for wire connections USB 2.0, and IEEE 1394 can be utilized. Other connections that are presently in the forefront of the state of the art for wireless high speed connections (greater than 500 Mbps) include the emerging Ultrawide Band (UWB) standard of WiFi (Wireless Fidelity) of which the latter is an order of magnitude slower.

Another embodiment of the invention provides for end users to take personally owned CD's/DVD's to a retailer or shop maintaining a Kiosk/Download Station 2, for requesting the latter to download the contents of the CD's/DVD's into the memory of the mobile device 8, avoiding the end user having to pursue ripping, transcoding, and so forth in order to accomplish the same result. In this regard, with this embodiment a unique fingerprint associated with each CD or DVD can be utilized. Such fingerprinting can be provided, for example, through use of a unique serial number on each associated disk by use of either BCA (an organization to protect copyrighted material) or Blu-ray (a new audio visual technology for DVD or digital video disk). Also it is known in the art that every CD and DVD has some unique physical characteristics that can be utilized for uniquely identifying each. In this manner, multiple users of the same CD/DVD can be prevented from going to a shop having a Kiosk/Download Station 2, or other such provider for downloading of the associated program material to a mobile device 8. In a similar manner, Hard Disk Drive (HDD) based home servers can be uniquely identified, whereby via use of an associated network all of the content or program material that a user has purchased can be securely downloaded from a Kiosk/Download Station 2 connected to the network, for permitting the user to listen to the program material on his server without ripping the CD's/DVD's he has purchased.

Note that the previous description of various embodiments of the invention has mainly dealt with the use of Kiosk/Download Stations 2 that are located in the shop of a retailer. The present invention is not meant to be so limited, and the Kiosk/Download Stations 2 can be located in other locations than the shop of a retailer, such as in shopping centers, movie theaters, and so forth.

With reference to FIG. 2, a flowchart is shown for the steps required in one embodiment of the invention in association with the purchase of a new mobile device 8 by a user. The first step 20 is to identify the mobile device 8 being purchased, and to relate the device 8 to the identified customer. This step 20 includes the retrieval of a public key, and the secure storage of the associated device ID for identification, using NFC (Near Field Communication). Note that typically a manufacturer or other system, respectively, preassigns a unique ID to each new device 8, making it unnecessary for the Kiosk/Download Station 2 to do so. However, if no ID preassignment was made, the latter can be programmed to do so. Assume that prior to the customer or user purchasing a new mobile device 8, previous purchases by the customer from the shop or retailer of various CD's and/or DVD's have been tracked, and included in the customer and device database 6 of the retailer for later access. This prior action makes step 22 viable for permitting the purchaser to select songs, or program material, owned by the purchaser and retained in the content database 4, for downloading into the new mobile device 8. Next, in step 24, a selected song or program material is encoded using a Public Key in the Download Station 2. The song or program material is then transferred in step 26 via download into the memory 10 of the newly purchased mobile device 8. After this transfer, the content database 4 is updated to include the song or program material (preferably as one single atomic transaction). Next, in decision step 28 it is determined whether additional songs or program material were selected for download, if not, step 30 is entered for terminating further action, whereas if so, then step 24 is reentered for downloading additional songs or program material into the newly purchased mobile device 8.

With reference to FIG. 3, in another embodiment of the invention, a customer or user of a previously purchased mobile or portable device 8 can visit a Kiosk/Download Station 2 location, be it in a shop or other public place, for purchasing new program material for download into the associated mobile device 8. A number of the steps of this embodiment of the invention are substantially the same as steps in the previously described embodiment of the invention associated with the flowchart of FIG. 2. The common steps between these two embodiments are identified by the same reference designation. The only steps that are different are steps 21 and 23. More specifically, assume that the customer or user decides to purchase one or more new CD's and/or DVD's which have program content, such as songs, that are identical with program material stored in the content database 4 of the shop or retail establishment, in this example. For example, unique physical properties of the disk of the CD/DVD are used in step 21 for providing the association of the physical content thereof with program material stored in the content database 4. Next, in step 23, songs or program material identified by the customer for downloading into the mobile device 8 are retrieved in step 23 from the content database 4. Thereafter, steps 24, 26, 28, and 30 are pursued as previously described for the embodiment of the invention as shown in the flowchart of FIG. 2.

Regardless of whether the embodiment of FIG. 2 or the embodiment of FIG. 3 is utilized, program material downloaded from the content database 4 to a customer or purchaser's portable or mobile device 8 in another embodiment of the invention can be coded or flagged to permit uploading to the PC 12 of the user/customer/purchaser. Coding can further be implemented in the program material to cause the flag to be reset for preventing any further uploading of the program material to other PC's. In addition, as previously indicated, software can be provided by the retailer to a customer for permitting the customer to manage their PC in uploading program material from their mobile device 8 into the memory of the PC 12. The software in a preferred embodiment will include security coding, such as DRM, for ensuring that the uploaded program content is stored securely in the customer's PC 12. In this manner, the customer or purchaser is prevented from sharing the program material with others. Through this embodiment of the invention, retailers, owners of copyright rights in the program material, and others who have an interest in protecting or securing the program material, are themselves protected in that in this manner, subsequent to purchasing the program material a user/customer/purchaser is prevented from illegally copying program material from CD's, DVD's, or from program material held in their PC 12.

More specifically, the various embodiments of the inventions not only provide protection to prevent illegal transfer of the program material by end users, but also provide distinct advantages to all parties concerned in the chain from the authors, songwriters, producers, manufacturers and distributors of mobile devices 8, and so forth, but also improve the efficiency in transactions between a retailer and their customers. Manufacturers of the mobile devices 8, through use of unique identification coding for each mobile device 8, gain a sales advantage over competitors in providing users with the ability to easily and very quickly download desired program material into their mobile devices 8. Such users can save money by retaining a record of their prior purchases of program material on CD's/DVD's at the Kiosk/Download Station 2 of a retailer, or can purchase such CD's/DVD's for immediate download to their mobile device 8, as previously described. In this manner, retailers are creating an incentive for customers to return to the retailer's establishment, rather than the customer making purchases over the Internet, or participating in illegal transfer of program material. By preventing customers or end users from illegally downloading program material into their mobile devices 8 through use of various of the embodiments of the invention, the providers of such program material (content industry) are able to maintain much greater control over the distribution of copyrighted material. Also, end users are provided with instant gratification through rapid download of program material to their mobile devices 8, in a high speed manner that is superior to the data transfer rates available with present state of the art broadband Internet connections, particularly when video program material is involved.

Through use of the various embodiments of the invention, a retailer will be able to offer many incentives to customers. For example, through use of a Kiosk/Download Station 2, a retailer will be able to easily offer bonus tracks to customers who have purchased designated collections of CD's/DVD's. An incentive program, for example, can provide that if a customer purchases three specifically designated CD's, the customer will also be provided with free bonus tracks for downloading to their mobile device 8, for example. Also, a customer can be permitted to buy non-CD's/DVD's individual tracks for downloading to their mobile device 8, such as presently provided by iTunes, a service that provides tracks not available on CD's. The latter service is provided over the Internet, whereby through use of the present invention a retailer will be able to offer such tracks to a customer for download to the mobile device 8, without any requirement that the customer themselves deal with the PC/Internet connections necessary to otherwise obtain such non-CD tracks.

Although various embodiments of the invention have been shown and described, they are not meant to be limiting. Those of ordinary skill in the art may recognize certain modifications to these embodiments, which modifications are meant to be covered by the spirit and scope of the appended claims. Also, although many embodiments of the invention are described in association with CD's/DVD's containing songs, as previously indicated, the program material is not meant to be so limited, and can include any digitized program material, such as software, navigation aids, games, and so forth.

1. A method for providing the secure and copy protected download and/or upload of program material including either audio content, video content, audio/video content, and/or software in association with a plurality of portable or playback/recording devices, said method comprising the steps of:
assigning, if not already preassigned, a unique device identification code (ID) to each one of said plurality of portable playback/recording devices;
assigning a unique user identification code to either or both of each owner of previously purchased digital content containing program material, and/or each owner of one of said plurality of portable playback/recording devices, respectively, whereby the code for a common owner of program material and a device can be the same code or individualized codes;
installing a Kiosk/Download Station (2) in a retail establishment in a shop or other public place, said station including a content database (4) for storing program material, and a customer and device database (6) for storing assigned device ID's and assigned user ID's;
programming said Kiosk/Download Station (2) for performing said device ID assigning, and for said user ID assigning steps, and further for the steps including:
permitting said user to select specific individual portions of program material contained in said content database (4);
encrypting each individual portion of the selected program material, for assignment to a specific device or user;
downloading individually each encoded portion of the selected program material from said content database (4) into a memory of the user's said device; and
updating said content database (4) to retain the selected program material.

2. The method of claim 1, wherein said step of programming said Kiosk/Download Station (2) further includes the steps of:
associating an ID of a user who purchases a new portable playback/recording device with the associated device ID; and
updating said customer and device database (6).

3. The method of claim 1, wherein said permitting step further includes said user only selecting portions of program material presently “owned” by said user and contained in said content database (4).

4. The method of claim 1, wherein the steps of programming said Kiosk/Download Station (2), further include for a user's purchasing new program material the steps of:
associating an ID code of newly purchased digital content of a user with the user's ID or device ID;
updating said customer and device database (6) in response to the immediately prior associating step;
uploading portions of program material contained in said newly purchased digital content therefrom into said content database (4) if not already included therein; and
said permitting step including said user selecting either individual or all portions of the newly acquired program material contained in said content database (4).

5. The method of claim 4, wherein said permitting step further includes either one of said user selecting portions of program material presently “owned” by said user and contained in said content database (4), or automatically selecting the program material portions.

6. The method of claim 5, wherein said step of programming said Kiosk/Download Station (2) further includes the steps of:
associating an ID of a user who purchases a new portable playback/recording device with the associated device ID; and
updating said customer and device database (6).

7. The method of claim 2, further including the step of:
preinstalling in said newly purchased device, prior to delivery to said user, program material “owned” and selected by said user.

8. The method of claim 1, further including the steps of:
receiving a user's said device for downloading program material thereto;
associating the user's ID with the ID of the user's device; and
successively repeating said permitting, encrypting, and downloading steps for downloading selected program material owned by said user.

9. The method of claim 1, wherein said encoding step uses a DRM model, for insuring a user can only offload program material from the user's said device to the user's PC, and thereafter only maintain the program material in the PC as backup solely for downloading back to the user's device, while prohibiting consumption on any other device of the program material.

10. The method of claim 4, wherein said newly purchased digital content can be either one or a combination of digital content purchased from a retailer, and digital content purchased over the Internet.

11. A Kiosk/Download Station (2) apparatus for location in public places including retail establishments, for providing a service to customers/users that includes the secure and copy protected download of program material from the Kiosk into portable playback/recording devices of respective customers, in a manner for copy protecting later uploading of program material by customers/users from such a device into their PC as a backup copy, said program material including either audio content, video content, audio/video content, or software, said Kiosk/Download Station (2) comprising:
a content database (4) for storing program material;
a customer and device database (6) for storing unique user ID codes for each customer, and unique device ID codes for each one of said devices identifiable in relation to a customer ID owner and/or program material;
programmable controller means for selectively uploading program material into said content database (4), and customer/device ID codes into said customer and device database (6), said programmable controller means being programmed to follow the steps including:
assigning, if not originally preassigned, a unique device identification code (ID) to each one of said plurality of portable playback/recording devices;
assigning a unique user identification code to either or both of each owner of previously purchased digital content containing program material, and/or each owner of one of said plurality of portable playback/recording devices, respectively;
selecting specific individual portions of program material contained in said content database (4);
encrypting each individual portion of the selected program material through use of a public key; and
downloading individually each encoded portion of the selected program material from said content database (4) into a memory of the user's said device.

12. The apparatus of claim 11, wherein said programmable controller means includes a microprocessor.

13. The apparatus of claim 11, wherein the programming of said programmable controller means further includes the steps of:
associating an ID of a user who purchases a new portable playback/recording device with the associated device ID; and
updating said customer and device database (6).

14. The apparatus of claim 11, wherein said permitting step further includes said user only selecting portions of program material presently “owned” by said user and contained in said content database (4).

15. The apparatus of claim 11, wherein the programming of said programmable controller means further includes for a user's purchasing new program material the steps of:
associating an ID code of newly purchased digital content of a user with the user's ID;
updating said customer and device database (6) in response to the immediately prior associating step;
uploading reference identification codes for newly purchased program material therefrom into said content database (4) if not already included therein; and
said permitting step including said user selecting either individual or all portions of the newly acquired program material contained in said content database (4).

16. The apparatus of claim 15, wherein said permitting step further includes said user selecting portions of program material presently “owned” by said user and contained in said content database (4).

17. The apparatus of claim 16, wherein the programming of said programmable controller means further includes the steps of:
associating an ID of a user who purchases a new portable playback/recording device with the associated device ID; and
updating said customer and device database (6).

18. The apparatus of claim 13, wherein the programming of said programmable controller further includes the step of:
preinstalling in said newly purchased device, prior to delivery to said user, program material “owned” and selected by said user.

19. The apparatus of claim 11, wherein the programming of said programmable controller further includes the steps of:
receiving a user's said device for downloading program material thereto;
associating the user's ID with the ID of the user's device; and
successively repeating said permitting, encryption, and downloading steps for downloading selected program material owned by said user.

20. The apparatus of claim 11, wherein the programming of said programmable controller further includes said encoding step using a DRM model, for insuring a user can only offload program material from the user's said device to the user's PC, and thereafter only maintain the program material in the PC as backup solely for downloading back to the user's device, while prohibiting any other copying of the program material.

21. The apparatus of claim 15, wherein said newly purchased digital content can be either one or a combination of digital content originals obtained from a retailer, and digital content having program material downloaded thereto from the Internet.

22. A Kiosk/Download Station (2) for location in a retail establishment or other public place, said Kiosk/Download Station (2) comprising:
a content database (4) for program material including audio, video, software, and/or audio/visual program material;
a customer and device database (6) for customer ID's, and associated portable audio and/or audio/visual playback/recording device (8) ID's;
means for assigning a unique ID to each customer, and (if not already preassigned by a manufacturer or other system) to each customer owned said device (8), for storage in said customer and device database (6);
means for assigning a unique ID to each previously and/or newly purchased digital content of a customer, for storage in said customer and device database (6);
means for uploading into said content database (4) program material from said digital content identifiable to and owned by said customer; and
download means for selectively downloading customer owned program material from said content database (4) into a said device (8) of said customer.

23. The Kiosk/Download Station (2) of claim 22, further including:
encryption means for encoding customer selected program material as it is downloaded to a customer device (8), for preventing unauthorized copying of the material from the associated customer device (8).

24. The Kiosk/Download Station (2) of claim 23, wherein said encoding means further includes:
means for allowing a customer to make a backup copy of said program material by uploading it from the customer's said device (8) to a PC (12) of the customer.
